(19) United States
(12) Patent Application Publication
(10) Pub. No.: US 2012/0144886 A1
(43) Pub. Date: Jun. 14, 2012

(54) Anti-theft lock assembly for universal key switches and locks

(76) Inventor: Eric Wolfgang Melchior, Appling, GA (US)

(21) Appl. No.: 13/200,182

(22) Filed: Sep. 20, 2011

Related U.S. Application Data
(60) Provisional application No. 61/459,456, filed on Dec. 13, 2010.

(51) Int. Cl. E05B 73/00

(52) U.S. Cl. 70/58

(57) ABSTRACT

An anti-theft lock assembly used in conjunction with ignition switches and locks which are operated by universal keys. The device can be attached to, and operate, the universal switch or lock by the use of non-universal key. Once the device is attached to the universal switch or lock the key to operate the device can be turned to the key lock position and then extracted, locking the device to the universal key switch or lock, therefore restricting the ability to operate the switch or lock with a universal key. The device can be easily removed by simply inserting the key into the device, rotating the key to the vertical position and removing the device, giving on the ability to operate the switch or lock with the universal key as normal. The device does not, however, need to be removed in order to operate the switch or lock. With the device attached, the switch or lock can be operated in the same manner as before using the key provided with the device to operate the switch or lock.

### CROSS-REFERENCE TO RELATED APPLICATIONS

This application claims the benefit of provisional patent application Ser. No. 61/459,456, filed 2010 Dec. 13 by the present inventor.

### BACKGROUND

Universal key switches and locks are a “one key fits all” type switch or lock used by manufacturers of heavy equipment, golf carts, ATV's, lawn mowers, etc. For example: All “John Deere” equipment utilizes the same key; therefore anyone possessing a “John Deere” key can operate any John Deere tractor and also unlock any locked panels or doors on the equipment to gain access to the engine compartment, cab of the tractor, etc. Each manufacturer has their “own” key, however, for example: A “John Deere” key will not work on a “Caterpillar” tractor, Caterpillar has its “own” key which operates Caterpillar equipment the same way as a “John Deere” key operates John Deere equipment. Every heavy equipment manufacturer has their “own” key. This is also the case with golf carts (Example: Club Car, and EZ Go), ATV's, lawn mowers and practically every type of construction equipment that utilizes a key.

In order to keep the background of universal keys from becoming too lengthy we will primarily focus on heavy equipment (being it is the most costly of things that utilize universal keys), however, most of what is discussed also pertains to all other types of equipment that utilize universal keys.

Unfortunately for equipment owners (fortunately for thieves and vandals) universal keys are a necessary evil in the construction industry. Listed below are just a few of the “pros and cons” of universal keys.

### Pros:

1) A particular piece of equipment may be used by multiple people on many job sites. In this situation it would be nearly impossible to keep up with one particular key for each piece of equipment.

2) A piece of equipment may need to be moved from one job-site to another by a private contractor. In this situation the private contractor would need to have the ability to enter and operate the piece of equipment in order to load and unload it.

### Cons:

1) Universal keys are readily available at any local dealer or locksmith for sale to anyone who asks for one.
2) Many dealers and internet retailers offer “Ring of Keys” for sale containing multiple numbered keys with a chart as to which key fits a particular manufacturer's equipment.
3) Universal keys are by far the single largest contributor to equipment being stolen or vandalized.
4) Universal keys provide an inconspicuous way for thieves to steal equipment. Thieves can access the equipment without drawing attention to themselves since they will not have to manipulate any lock or ignition switch in anyway. If caught, universal keys give them the ability to use the “mistake excuse” by simply claiming that they thought a particular piece of equipment is the one they were supposed to be moving.

On average, a piece of heavy equipment contains an ignition switch and up to a dozen or more locks. The locks are in place on all access doors to the engine compartment, battery boxes, and various other access panels on the piece of equipment to deter theft (I.E.: Theft of batteries) and vandalism (I.E.: Someone putting dirt into the engine oil, transmission, hydraulic system, fuel system, etc.).

Theft and vandalism of heavy equipment are an extremely costly problem for everyone in the construction industry. Cited below are just a few examples of the severity of this problem:
1. More than 71 percent of equipment owners have experienced equipment theft in the past year. The types of equipment most frequently stolen are: loaders, light utility work trucks, generators, air compressors, welders, skid steers and fork and scissor lifts.
   2008 Cygnus Business Media Research Study
2. According to a recent customer survey by a leading equipment provider, $1.5 billion in heavy equipment is stolen each year nationwide.
   Caterpillar Customer Survey
3. The newest equipment is often the most coveted; more than 74 percent of the equipment stolen and recovered was five years old or less.
   Constructech, 2007
4. One third of thefts are reported on Monday morning and more than 70 percent are thefts from job-sites with lack of adequate security.
   2007 National Equipment Register Survey
5. As little as 6.5 percent of stolen equipment is recovered.
   2007 National Equipment Register Survey

As previously stated, theft of heavy equipment is an enormous problem for equipment owners, however, this is not the only problem that is simplified by the use of universal keys, vandalism is also a huge problem. As large of a problem as theft is, there is at least the chance that a piece of equipment which has been stolen may be recovered; however a piece of heavy equipment can be vandalized in many ways. The most costly form of equipment vandalism is when an engine compartment, fuel system, hydraulic system, transmission, etc. is entered (by the use of a universal key) and a foreign substance such as dirt, sugar, etc. is put into the engine oil, fuel system, transmission oil, etc. causing extensive damage to a piece of equipment, even to the point of rendering it useless. Vandalism may not be as costly as theft (per incident), however vandalism happens much more frequently than theft does, and in some cases can actually be more costly.

As previously stated, universal keys are by far the largest contributors to the theft and vandalism of heavy equipment. However, they are not limited to heavy equipment only; universal keys are also utilized in many other things such as: golf carts, ATV's, riding lawn mowers, and virtually every type of construction equipment that utilizes a key.

By utilizing the anti-theft lock assembly, a company or equipment owner with equipment from different manufacturers can now operate all of their equipment with only one key due to the ability to easily interchange the cylinder lock and universal key shaft in the device so that any combination of the two can easily be obtained. However, if someone that does not have the proper key to operate the device should need to operate the equipment (I.E.—private contractor hired to move equipment from one job site to another) or enter a locked engine compartment or panel (I.E.—an equipment dealers service technician needs to make a repair or perform a service), the device can be easily removed before hand by simply inserting the key into the device, turning it to the vertical position, and removing the device from the switch or lock, giving one the ability to operate or access the machine with the use of their manufacturers universal key. With the device in place on the locks and switch, an equipment owner can now have the peace of mind that when the equipment is left unattended it is protected against the most common cause of theft and vandalism due to the fact that not just anyone armed with a universal key will have the ability to enter, vandalize, or steal the equipment with the speed and ease that universal keys provide. In short, the anti-theft lock assembly would provide the option of being able to utilize the universal key as normal, or by attaching the device to the switch or lock, requiring the use of the key (provided with device) to be able to operate the switch or lock.

### SUMMARY

An anti-theft locking assembly, used on machinery (heavy equipment, golf carts, ATVs, etc.) which utilizes ignition switches and locks that are operated by universal keys. The device is a lock assembly designed to be used as a deterrent to theft and vandalism of heavy equipment and other types of equipment that are operated with universal keys. The device will be constructed in such a way as to mate with the switch or lock. The switch and lock will contain a key lock position. The only purpose of the key lock position is to keep the device from being able to be extracted from the switch or lock without the use of the provided key. By turning the key to the key lock position, the universal key shaft cannot be extracted from the switch or lock, however, the provided key can be can be extracted from the device, locking the device to the switch or lock. The outer portion of the device will freely rotate on itself causing the inability of the universal key shaft to be turned without the use of the provided key.

The universal switch and lock are designed in such a way as to accept the device. When coupled to the switch or lock the pressure is taken off the universal key shaft and access to the key shaft is eliminated. The device is assembled and disassembled from the rear, making it impossible to remove the device by dismantling it. Universal key shafts and lock cylinders are easily interchangeable allowing any desired combination to be easily obtained. The cylinder lock, key and washer will contain a stamped number.

### DRAWINGS

### Figures

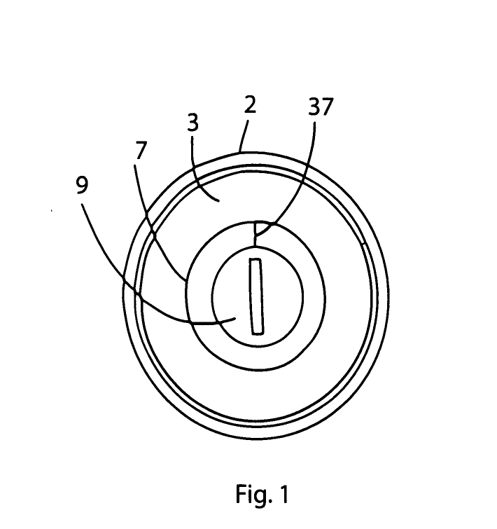

FIG. 1 is a front view of the device.

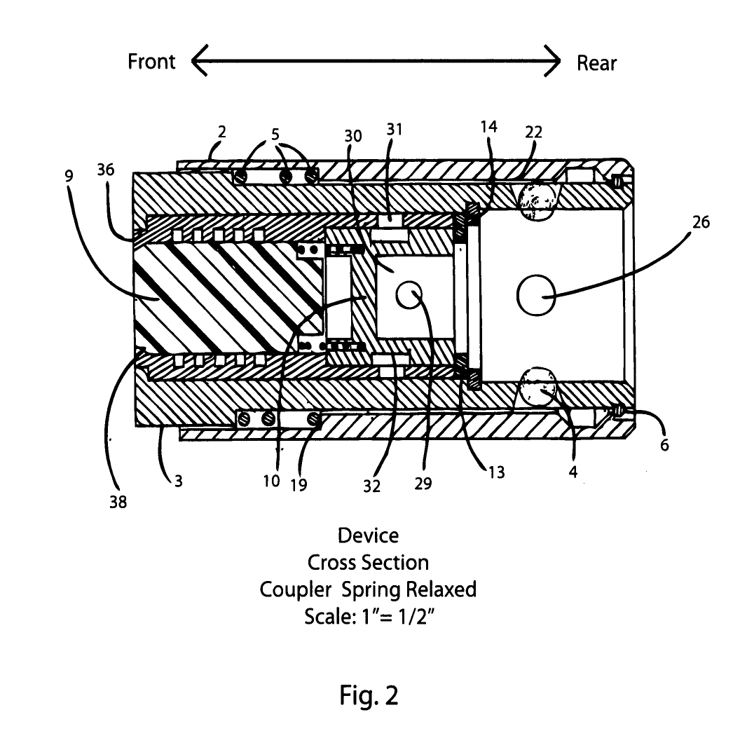

FIG. 2 is a cross-section of the device with the outer cylinder in the relaxed (rear) position, restricting the ability to insert or remove the device from the switch and lock housing.

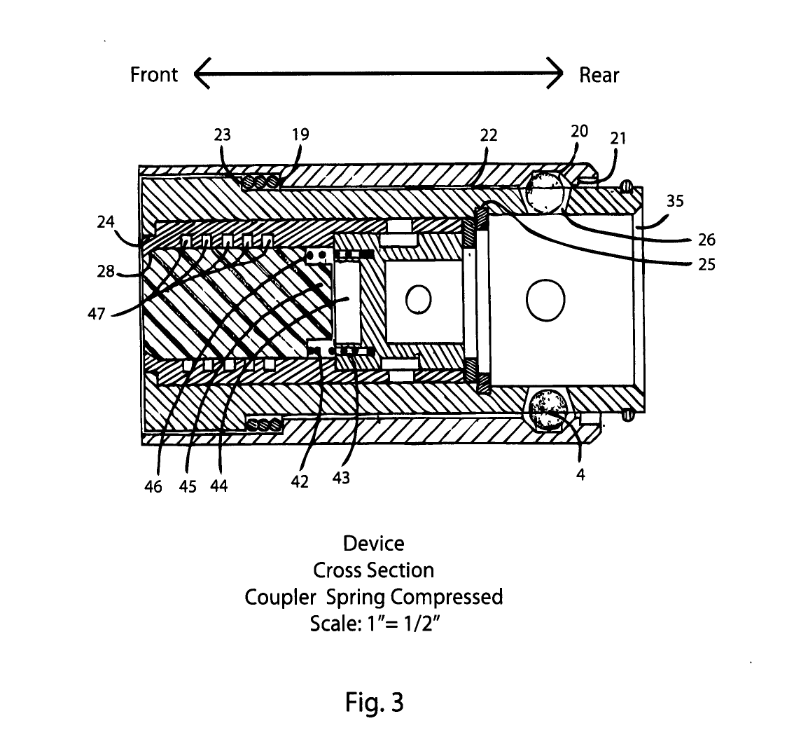

FIG. 3 is a cross-section of the device with the outer cylinder in the (forward) position allowing the ability to install or remove the device from the switch or lock housing.

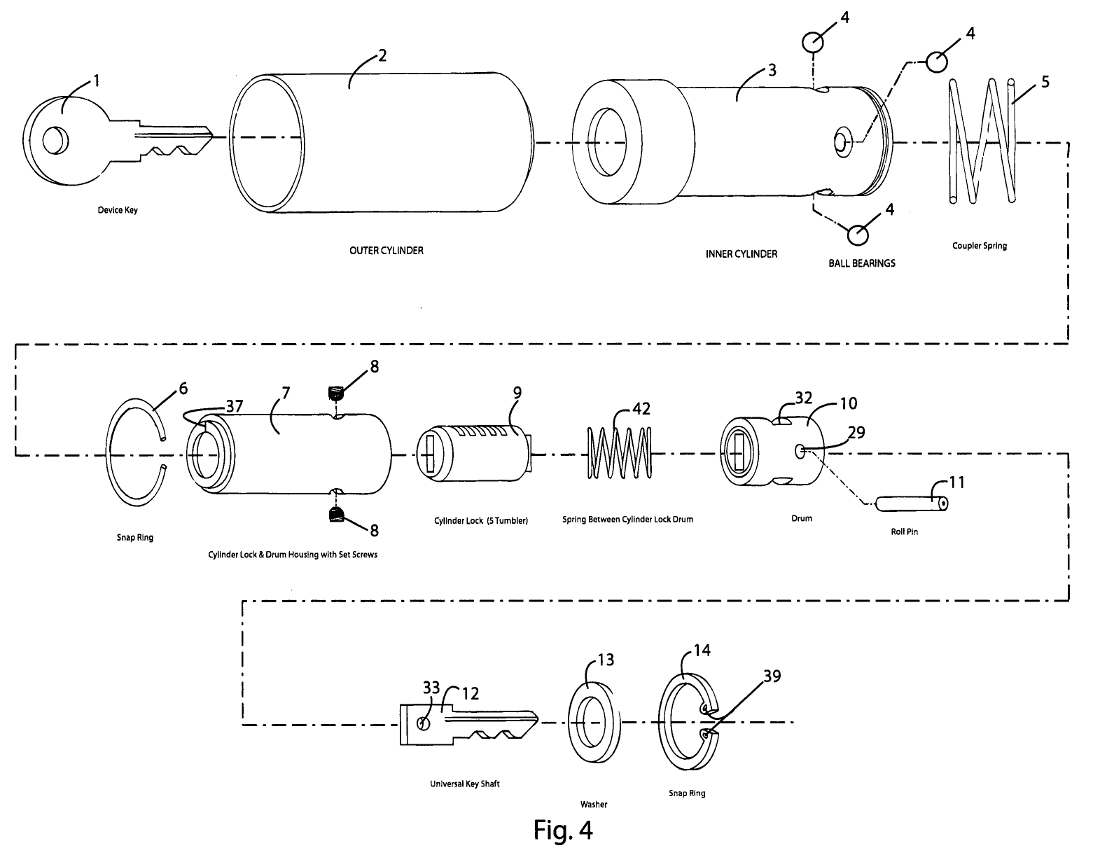

FIG. 4 is an exploded view of the device containing all embodiments used to construct the device.

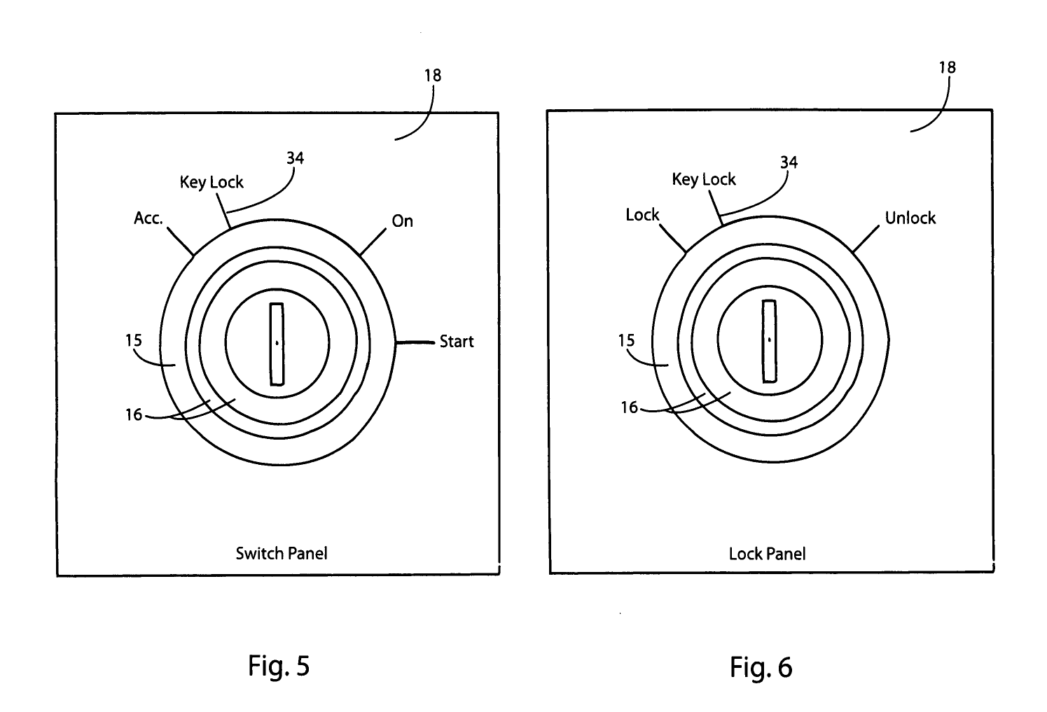

FIG. 5 is a front view of the switch and lock housing used with a ignition switch mounted on a switch panel.

FIG. 6 is a front view of the switch and lock housing used with a lock mounted on a panel.

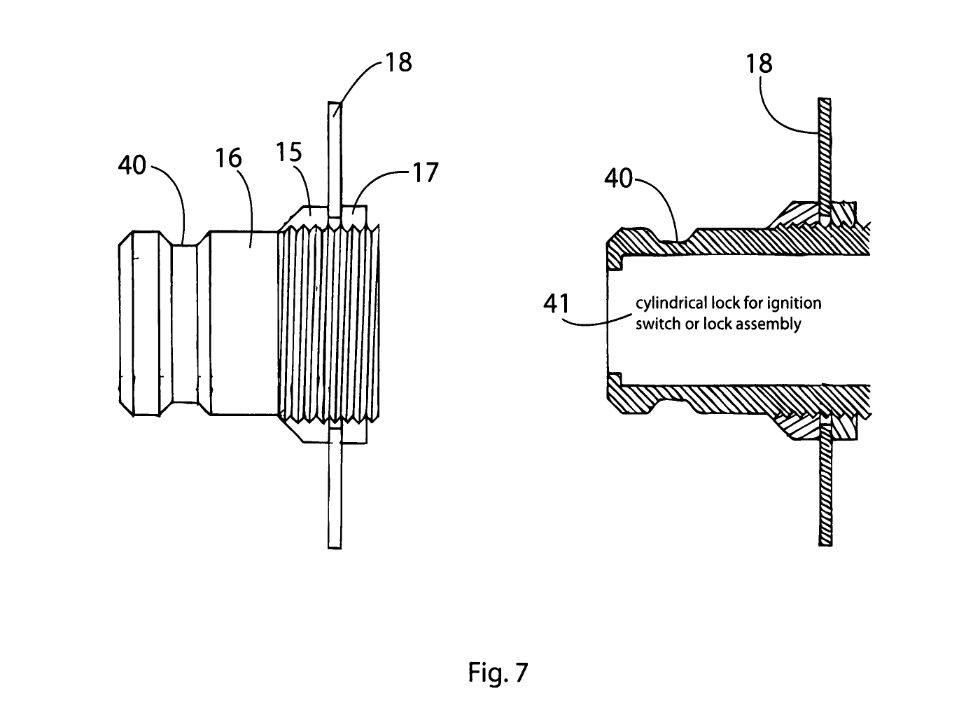

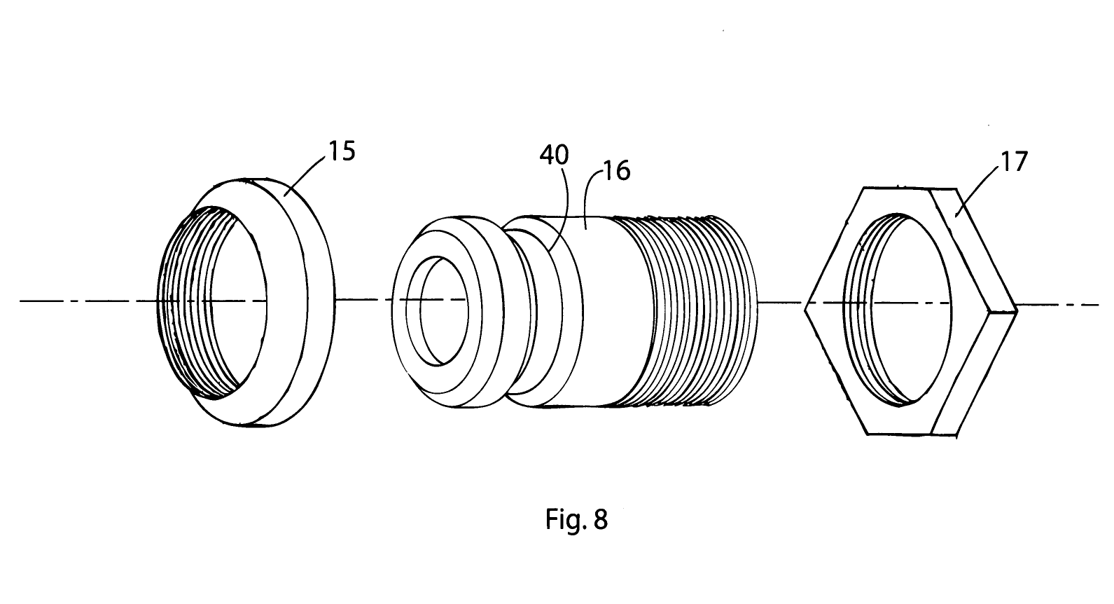

FIG. 7 is a side view and cross-section of the switch and lock housing and its components.

FIG. 8 is an exploded view of the switch and lock housing and its components.

### REFERENCE NUMERALS

1. Key (FIG. 4)
2. Outer Cylinder (FIGS. 1, 2, 4)
3. Inner Cylinder (FIGS. 1, 2, 4)
4. Ball Bearing (FIGS. 2, 4)
5. Spring (FIGS. 2, 4)
6. Coupler Snap Ring (FIGS. 2, 4)
7. Cylinder Lock and Drum Housing (FIGS. 1, 2, 4)
8. Set Screw (FIG. 4)
9. Cylinder Lock (FIGS. 1, 2, 4)
10. Drum (FIGS. 2, 4)
11. Roll Pin (FIG. 4)
12. Universal Key Shaft (FIG. 4)
13. Washer (FIGS. 2, 4)
14. Device Snap Ring (FIGS. 2, 4)
15. Cylindrical Nut (FIGS. 5, 6, 7, 8)
16. Switch and Lock Housing (FIGS. 5, 6, 7, 8)
17. Hex Nut (FIGS. 7, 8)
18. Panel (FIGS. 5, 6, 7)
19. Outer Cylinder Spring 5 Seat (FIGS. 2, 3)
20. Recess for Ball Bearing 4 (FIG. 3)
21. Coupler Snap Ring 6 Seat (FIG. 3)
22. Inner Wall of Outer Cylinder 2 (FIGS. 2, 3)
23. Inner Cylinder Spring 5 Seat (FIG. 3)
24. Lip on Front of Inner Cylinder 3 to contain Cylinder Lock and Drum Housing 7 (FIG. 3)
25. Recess on Inner Wall of Inner Cylinder for Device Snap Ring 14 (FIG. 3)
26. Tapered Holes for Ball Bearing (FIGS. 2, 3, 4)
27. Recess on Outer Wall of Inner Cylinder for Coupler Snap Ring 6 (FIG. 4)
28. Taper on Front of Cylinder Lock and Drum Housing 7 to contain Cylinder Lock 9 (FIG. 3)
29. Hole through Drum 10 to contain Roll Pin 11 (FIGS. 2, 4)
30. Slot in Drum 10 to contain Universal Key Shaft 12 (FIG. 2)
31. Threaded hole in Cylinder Lock and Drum Housing 7 to contain Set Screws 8 (FIG. 2)
32. Recess in Drum 10 for Set Screws 8 to be tightened against to Secure and Align Drum 10 to Cylinder Lock and Drum Housing 7 (FIGS. 2, 4)
33. Hole in Universal Key Shaft 12 for Roll Pin 11 to Secure Universal Key Shaft 12 to Drum 10 (FIG. 4)
34. Key Lock Position (FIGS. 5, 6)
35. Tapered End of Inner Cylinder (FIG. 3)
36. Recessed Portion on Front of Cylinder Lock and Drum Housing 7 (FIG. 2)
37. Mark on Cylinder Lock and Drum Housing for Alignment of Key (FIGS. 1, 4)
38. Tapered Portion of Front Outer Wall of Cylinder Lock (FIG. 2)
39. Holes in Snap Ring (FIG. 4)
40. Recessed Portion of Switch or Lock Housing (FIGS. 7, 8)
41. Location for cylindrical lock used with ignition switch or lock assembly (FIG. 7)
42. Spring between cylinder lock 9 and drum 10 (FIGS. 3, 4)
43. Slot in drum 10 to contain spring 42 (FIG. 3)
44. Slot in drum for appendage on rear of cylinder lock 45 (FIG. 3)
45. Appendage on rear of cylinder lock 9 (FIG. 3)
46. Spring seat on cylinder lock (FIG. 3)
47. Grooves inside CLDH 7 for cylinder lock 9 tumblers (FIG. 3)

### DETAILED DESCRIPTION

### First Embodiment

The following is a detailed description of the first embodiment referred to as the “device” as seen in FIGS. 1, 2, 3 and 4.

FIG. 1 is a front view of the device showing the location of the outer cylinder 2, inner cylinder 3, cylinder lock and drum housing 7, cylinder lock 9 and the alignment mark 37 in respect to each other from a frontal view.

FIG. 2 is a cross-section of the device with the outer cylinder 2 in the relaxed position. In this position the spring 5 applies pressure to the outer cylinder spring seat 19 forcing the outer cylinder 2 towards the rear of the device until the coupler snap ring seat 21, as seen in FIG. 3, comes into contact with the coupler snap ring 6. At this point the ball bearings 4 are forced to penetrate the interior wall of the inner cylinder 3 by the inner wall of the outer cylinder 22, restricting the ability to insert or remove the device from the switch and lock housing 16 (seen in FIGS. 5,6,7 and 8).

FIG. 3 is a cross-section of the device with the outer cylinder 2 in the (forward) position. In this position the outer cylinder 2 is pulled toward the front of the device compressing the spring 5 between the inner cylinder spring seat 23 and the outer cylinder spring seat 19, thus allowing the ball bearings 4 to enter the recessed portion of the outer cylinder 20 allowing the ability to install or remove the device from the switch and lock housing 16 (seen in FIGS. 5,6,7 and 8).

FIG. 4 is an exploded view of the device containing all embodiments used to construct the device.

A) The key is used to operate the universal key shaft 12. Only when the key 1 is fully inserted into the cylinder lock 9 in alignment with the mark 37 on the cylinder lock and drum housing 7 will the appendage on the rear of the cylinder lock 45 have the ability to be inserted in the slot in the drum 44 allowing the universal key shaft 12 to be operated by the use of the key 1.

B) The outer cylinder 2 has two main functions. The outer cylinder 2 freely rotates on the inner cylinder 3 causing the inability for the universal key shaft 12 to be turned by turning the outer cylinder 2. The outer cylinder 2 also works in conjunction with the inner cylinder 3 as a coupling device which secures the device to the switch and lock housing 16 (seen in FIGS. 5,6,7, and 8).

C) The inner cylinder 3 freely rotates on the CLDH 7 and inside of the outer cylinder 2. The inner cylinder 3 is used to contain the CLDH 7 and as previously stated, work in conjunction with the outer cylinder 2 as a coupling device. The inner cylinder 3 contains a recessed portion on the outer wall 27 used to house the coupler snap ring 6. The inner cylinder 3 also contains four tapered holes 26 used to contain the four ball bearings 4.

D) The four ball bearings 4 are located in the tapered holes 26 in the inner cylinder 3 and work in conjunction with the outer cylinder 2 in order to allow or restrict the ability to install or remove the device from the switch and lock housing 16 depending on the location of the outer cylinder 2, as previously described in FIG. 2 and FIG. 3.

E) The spring 5 is located toward the front of the device between the inner cylinder 3 and the outer cylinder 2. The spring 5 is used to allow forward and backward movement of the outer cylinder 2 as previously described in FIG. 2 and FIG. 3.

F) The coupler snap ring 6 is located at the rear of the inner cylinder 3 inside the recess on the outer wall of the inner cylinder 27. The coupler snap ring 6 has two purposes. The coupler snap ring 6 holds the outer cylinder 2 in its desired position against the pressure being applied to the outer cylinder 2 by the spring 5. The coupler snap ring 6 can be removed giving one the ability to remove the outer cylinder 2 from the device in order to gain access to the spring 5 and also the four ball bearings 4.

G) The cylinder lock and drum housing or CLDH 7 is located and freely rotates inside the inner cylinder 3. The CLDH 7 is the portion of the device which houses the cylinder lock 9 and the drum 10. The CLDH 7 contains two threaded holes to accommodate the set screws 8 used to secure the drum 10 to the CLDH 7. The CLDH 7 also contains an alignment mark 37 used to properly align the CLDH 7 with the cylinder lock 9.

H) The cylinder lock 9, located inside of the CLDH 7, is the portion of the device used in conjunction with the key 1 to operate the universal key shaft 12.

I) The spring 42 housed inside the CLDH 7 between the cylinder lock 9 and the drum 10 is used to keep pressure against the back of the cylinder lock 9 forcing it towards the front of the CLDH 7 so that the tumblers in the cylinder lock 9 will be inside the grooves 47 located inside the CLDH 7 restricting the ability to operate the universal key shaft 12 unless the proper key 1 is fully inserted.

J) The drum 10 is located inside the CLDH 7 behind the cylinder lock 9 and is used to house the universal key shaft 12. The universal key shaft 12 is inserted into the slot in the drum 30 as seen in FIG. 2 and secured with the roll pin 11 by inserting the roll pin 11 into the hole in the drum 29, through the hole in the universal key shaft 33 and back into the hole in the drum on the other side of the slot that contains the universal key shaft 30 seen in FIG. 2. The drum 10 is secured to and aligned with the inner cylinder 3 by tightening the two set screws 8 against the recessed portion of the drum 32.

K) The universal key shaft 12 is located at the rear of the device and secured to the drum 10 by the roll pin 11. The universal key shaft 12 is used to operate the universal switch or lock as a universal key would if the device were not attached to the switch or lock.

L) The washer 13 is located behind the drum and used to keep the internal parts of the device in place. The washer 13 also contains a clearly visible stamped number which coincides with the numbered cylinder lock 9 and key 1 so that someone can quickly determine which key operates the device without having to dismantle the device in order to access the cylinder lock 9, however, the number cannot be seen when the device is attached to the switch and lock housing 16.

M) The snap ring 14 is located behind the washer 13 inside the inner cylinder 3 and held in place by the recessed portion of the inner wall of the inner cylinder 25 as seen in FIG. 3. The snap ring 14 is used to keep the internal portions of the device in place.

### OPERATION

### First Embodiment

1. Key—The key 1 is used to operate the universal key shaft 12. Only when the key 1 is fully inserted into the cylinder lock 9 in alignment with the mark 37 on the cylinder lock and drum housing 7 will the appendage on the rear of the cylinder lock 45 have the ability to be inserted into the slot in the drum 44 allowing the universal key shaft 12 to be operated by the use of the key 1.

2. Outer Cylinder—The Outer Cylinder 2 has two main functions. The outer cylinder 2 freely rotates on the inner cylinder 3 causing the inability for the universal key shaft 12 to be turned clockwise or counter clockwise by turning the outer cylinder 2. The outer cylinder 2 also works with the inner cylinder 3 as a coupling device which secures the device to the switch or lock housing 16.

By coupling the device to the switch or lock housing 16, pressure is removed from the universal key shaft 12 and also does not allow the universal key shaft 12 to be accessed in any way while the device is coupled to the switch or lock housing 16.

In order to couple the device to the switch or lock housing 16, the outer cylinder 2 must be pulled toward the front of the device. When the spring 5 is completely compressed FIG. 3, the recessed portion 20 of the outer cylinder 2 passes over the tapered holes for the ball bearings 26 in the inner cylinder 3 allowing the ball bearings 4 to enter the recessed portion 24 of the outer cylinder 2, in turn allowing the inner cylinder 3 to pass over the switch or lock housing 16.

When the outer cylinder 2 is released FIG. 2, the pressure applied by the spring 5 to the spring seat on the outer cylinder 19 forces the outer cylinder 2 to move towards the back of the device until the coupler snap ring seat 21 contacts the coupler snap ring 6. When this occurs, the spring pressure keeps the outer cylinder 2 from moving forward and the coupler snap ring 6 keeps the outer cylinder 2 from moving backward. At this point the inner wall 22 of the outer cylinder 2 applies pressure to the ball bearings 4, forcing them to the bottom of the tapered holes 26 in the inner cylinder 3 to the point where a portion of the ball bearings 4 passes through the inner wall of the inner cylinder 3 and into the recessed portion of the switch or lock housing 33 locking the device to the switch or lock housing 16.

At this point if the key 1 is turned to the key lock position 34 (or any position besides the vertical position); the device cannot be extracted because the universal key shaft 12 is locked in the switch or lock in these positions. The only way the device can be removed from the switch or lock housing 16 is by turning the key 1 to the vertical position (unlocking the universal key shaft 12 from the switch or lock), then pulling the outer cylinder 2 towards the front of the device until the recessed portion of the outer cylinder 20 passes over the ball bearings.

3. Inner Cylinder—The inner cylinder 3 freely rotates on the cylinder lock and drum housing 7, and inside the outer cylinder 2. The purposes of the inner cylinder 3 are to 1) Work in conjunction with the outer cylinder 2 as a coupling device. 2) Contain the cylinder lock and drum housing 7.

The inner cylinder 3 is used as a coupling device in conjunction with the outer cylinder 2. The inner cylinder 3 contains a raised ledge on the outer portion of the inner cylinder 3 towards the front which acts as the spring seat 23. The inner cylinder spring seat 23 works in conjunction with the spring seat on the outer cylinder 19 to contain the spring in its desired location. The inner cylinder also contains the four tapered holes for the ball bearings 26 and a recessed portion on the outside of the inner cylinder towards the back 27 to contain the coupler snap ring 6.

On the interior of the inner cylinder 3 is a lip in the front 24 and a recessed portion 25 towards the rear. The lip in the front 24 of the inner cylinder 3 is used to keep the cylinder lock and drum housing 7 from being able to be extracted from the front of the device. The recessed portion towards the rear 25 contains the device snap ring 14 used to keep the internal parts of the device in place. The back end of the inner cylinder is tapered 35 so the device can be easily attached to the switch or lock housing 16.

4. Ball Bearings—The ball bearings 4 are used to attach the device to the switch or lock housing 16. The four ball bearings 4 are located inside the tapered holes 26 in the inner cylinder 3. When the outer cylinder 2 is pulled forward FIG. 3 the recessed portion 20 of the outer cylinder aligns with the tapered holes 26 in the inner cylinder 3 allowing the four ball bearings 4 to enter the recessed portion 20 of the outer cylinder 2 and pass over the switch or lock housing.

When the outer cylinder 2 is released FIG. 2 the four ball bearings 4 are forced down penetrating the interior wall of the inner cylinder 3. When the device is attached to the switch or lock housing 16 and the outer cylinder 2 is released, the four ball bearings 4 penetrate the interior wall of the inner cylinder 3 and extend into the recessed portion 40 of the switch and lock housing 16 affixing the device to the switch and lock housing 16.

5. Spring—The spring 5 is located toward the front of the device between the outer cylinder 2 and the inner cylinder 3. The springs 5 purpose is to allow the outer cylinder 2 to be pulled toward the front of the device (allowing free travel of the ball bearings FIG. 3, or when released, push the outer cylinder 2 towards the rear of the device until the coupler snap ring seat 21 comes into contact with the coupler snap ring 6 (causing the four ball bearings 4 to penetrate the interior wall of the inner cylinder 3 as seen in FIG. 2).

6. Coupler Snap Ring—The coupler snap ring 6 is located at the rear of the inner cylinder 3 inside the recess on the outer wall of the inner cylinder 27. The coupler snap ring 6 has two purposes. The coupler snap ring 6 holds the outer cylinder 2 in its desired position against the pressure being applied to the outer cylinder 2 by the spring 5. The coupler snap ring 6 can be removed giving one the ability to remove the outer cylinder 2 from the device and gain access to the spring 5 and also the four ball bearings 4.

7. Cylinder Lock and Drum Housing—The cylinder lock and drum housing 7 is the portion of the device which houses the cylinder lock 9, the spring 42, and the drum 10. The CLDH 7 has a recessed portion 36 on the front of the outer wall which mates with the lip on the inner wall of the inner cylinder 24 keeping the CLDH 7 from being extracted through the front of the device. The CLDH 7 also contains a taper on the front inside wall 28 to contain the cylinder lock 9 and eliminate the ability to remove the cylinder lock 9 through the front of the device. Toward the rear of the CLDH 7 are two threaded holes 31 which contain the two set screws 8 used to secure the drum 10 to the CLDH 7. The cylinder lock 9 will freely rotate inside the CLDH 7. The key 1 must be in proper alignment with the mark 37 on the face of the CLDH 7 in order for the cylinder lock 9 to be able to engage the drum 10 so that the universal key shaft 12 can be operated by the key 1. The CLDH 7 is held in place from the rear by the washer 13 and the snap ring 14.

8. Set Screw—The device contains two set screws 8. The set screws 8 are located inside the two threaded holes 31 in the CLDH 7. The purpose of the set screws is to secure the drum 10 to the CLDH 7. The drum 10 is secured to the CLDH 7 by tightening the set screws 8 against the two flat surfaces 32. By tightening the set screws 8 against the flat surfaces 32 of the drum 10 the universal key shaft 12 will be in proper alignment with the mark 37 on the face of the CLDH 7. By using set screws 8 to attach the drum 10 to the CLDH 7 the drum 10 can be easily accessed and removed in order to change universal key shafts and access to the cylinder lock 9 can be achieved.

9. Cylinder Lock—The cylinder lock 9 to be constructed to industry standards. The cylinder lock 9 will freely rotate inside the CLDH 7 until which time the key 1 is in alignment with the mark 37 on the face of the CLDH 7 and fully inserted into the cylinder lock 9, at this time the cylinder lock 9 can be pushed inward against the pressure applied by the spring 42 allowing the appendage 45 on the back of the cylinder lock 9 to enter the slot in the drum 44. When the appendage 45 is inside the slot in the drum 44 the universal key shaft 12 can be operated by the use of the key 1.

There is to be a tapered portion 38 on the front outside wall of the cylinder lock 9. This tapered portion 38 of the cylinder lock 9 will mate with tapered portion 28 on the front of the CDHL 7 preventing the cylinder lock 9 from being extracted through the front.

42. Spring—The spring 42 is located between the cylinder lock 9 and the drum 10 inside the CLDH 7. The springs purpose is to keep pressure applied to the rear of the cylinder lock 9 forcing is toward the front of the device so that when the key 1 is removed from the cylinder lock 9, the cylinder lock 9 will be in its forward most position allowing the tumblers in the cylinder lock 9 to protrude into the grooves 47 inside the CLDH 7 when the key 1 is extracted. At this point the cylinder lock 9 will freely spin inside the CLHD 7 and the ability to push the cylinder lock 9 inward is restricted without the use of the proper key 1.

10. Drum—The drum 10 is the portion of the device which contains the universal key shaft 12. The drum 10 is located inside the CLDH 7 and behind the cylinder lock 9. The drum 10 is secured to the CLDH 7 by two set screws 8. The drum 10 also contains a hole 29 through it perpendicular to the slot 30 for the key shaft, and parallel to the flat spots 32 on the drum. To secure the universal key shaft 12 to the drum 10, the universal key shaft 12 must be pushed into the slot 30 from the rear of the drum 10 until the hole in the universal key shaft 33 aligns with the two holes in the drum 29 at which time the roll pin 11 is to be inserted into one of the holes in the drum 29 pass through the hole in the universal key shaft 33 and into the other hole in the drum 29. At this point the universal key shaft 12 is attached to the drum 10.

The drum 10 also contains a slot 44 which works in conjunction with the appendage 45 on the back of the cylinder lock 9 as previously described. The drum 10 also contains a slot 43 which is used to house the spring 42 so that when the cylinder lock 9 is pushed forward, the spring 42 will not restrict the ability of the appendage 45 on the rear of the cylinder lock 9 to enter the slot 44 during the operation of this device.

11. Roll Pin—The roll pin 11 is the portion of the device which when passed through both the holes 29 in the drum and the hole 33 in the universal key shaft, secures the universal key shaft 12 to the drum 10.

12. Universal Key Shaft—The universal key shaft 12 is used to operate the switch or lock in the same manner as the universal key would if the device is not attached to the switch or lock housing 16. The universal key shaft 12 contains a hole 33 in the front portion of the universal key shaft 12, which the roll pin 11 passes through to secure the universal key shaft 12 to the drum 10 after the front of the universal key shaft 12 is pushed into the slot 30 in the rear of the drum 10.

13. Washer—The washer 13 is the portion of the device used to contain the CLDH 7 from the rear of the device. The washer 13 is applied to the device by pulling the outer cylinder 2 forward, releasing the pressure off the ball bearings 4. When this is done the washer 13 can be inserted into the cavity in the rear of the device over the universal key shaft 12 and against the rear of the CLDH 7. At this point the device snap ring 14 can be applied behind the washer 13 securing the CLDH 7 inside the inner cylinder 3. The washer 13 is to contain a stamped number corresponding with that of the key 1 and cylinder lock 9 for being able to easily identify which key 1 is to be used with the device. The number on the washer 13 cannot be viewed while the device is attached to a switch or lock.

14. Device Snap Ring—The device snap ring 14 is used to contain all the inner parts of the device in place from the rear of the device. To install or remove the device snap ring 14 from the device, pressure must be taken off the ball bearings 4 by pulling the outer cylinder 2 toward the front of the device. Then, with the use of snap ring pliers, the device snap ring 14 is to be compressed, then enter in through the rear of the device, placed against the washer 13 and over the recess on the inner wall 25 of the inner cylinder 3. At this point pressure can be taken off the device snap ring 14 causing it to enter the recessed portion 25 of the inner cylinder 3 securing it to the inner cylinder 3.

### Second Embodiment

The following is a detailed description of the second embodiment referred to as the switch and lock housing as seen in FIGS. 5,6,7, and 8.

FIG. 5 is a front view of the switch and lock housing 16 used with an ignition switch assembly mounted on a switch panel 18. In this view the cylindrical nut 15, switch and lock housing 16 and panel 18 in which the switch and lock housing 16 is mounted, are shown in respect to each other from a frontal view. The location of the key lock position 34, which will be discussed in the operation, is also shown in FIG. 5.

FIG. 6 is a front view of the switch and lock housing 16 used with a lock assembly mounted on a door or service panel 18. In this view the cylindrical nut 15, switch and lock housing 16 and panel 18 in which the switch and lock housing 16 is mounted, are shown in respect to each other from a frontal view. The location of the key lock position 34, which will be discussed in the operation, is also shown in FIG. 6.

FIG. 7 is a side view and cross-section of the switch and lock housing 16. This figure shows the cylindrical nut 15, switch and lock housing 16 and hex nut 17 mounted on the panel 18. FIG. 7 also shows the location of the recessed portion of the switch or lock housing 40 and the location of the cylindrical lock for the ignition switch or lock assembly 41. The rear portion of the switches and locks in this Figure will be made to manufacturers specifications and have been omitted due to the hundreds of variations that are possible.

FIG. 8 is an exploded view of the switch and lock housing 16 containing the cylindrical nut 15, switch and lock housing 16 and hex nut 17. Also shown in this figure is the location of the recessed portion of the switch and lock housing 40. The rear portion of the switches and locks in this Figure will be made to manufacturers specifications and have been omitted due to the hundreds of variations that are possible.

### Second Embodiment

The switch or lock housing is designed to mate with the device and contain the cylinder lock and other mechanical or electrical parts used to comprise the switch or lock to manufacturers specifications as done in the industry.

The cylinder lock will, however, contain an extra position located approximately 22.5 degrees or 1/16 of a turn to the left of vertical, this being the key lock position 34 as seen in FIG. 5 and FIG. 6. The only purpose the key lock position 34 serves is, in this position the universal key or universal key shaft 12 cannot be extracted, however no other functions of the switch or lock are being utilized. When the device is attached to the switch or lock housing 16, the key 1 may then be turned to the key lock position and removed from the device essentially locking the device to the switch or lock housing 16.

The key 1 will be used to operate the switch or lock in the same manner as the universal key would if the device were not attached.

The switch or lock housing 16 contains a recessed portion on the outer wall 40 of the cylindrical housing to accommodate the ball bearings 4 located in the device for the purpose of coupling the device to the switch or lock housing 16 in the manner as previously described.

The cylindrical nut 15 works in conjunction with the Hex nut 17 to secure the switch or lock housing 16 to the panel 18 on which it is to be mounted.

### CONCLUSION, RAMIFICATIONS, AND SCOPE

Accordingly, the reader will see that the anti-theft lock assembly for switches and locks operated by universal keys will greatly aid in the reduction of theft and vandalism of all types of construction equipment, as well as anything else (ex. Lawn mowers, golf carts, tool boxes, etc.), which utilizes universal keys to open or operate. As previously discussed, universal keys are a necessary evil for a multitude of reasons. Due to the ease of obtaining universal keys, virtually anyone has the ability to obtain a key fitting anything which is operated or locked by the use of the universal key. This allows one to steal or vandalize the particular item with the greatest of ease.

The Anti-theft lock assembly consists of a switch or lock built to manufacturers specifications operated by their universal key. The switch or lock is altered in such a manner as to mate with a separate keyed device which can be attached to the manufacturers switch or lock and secured by the use of an alternate key. The keyed device can be used to simply deny access of the manufacturers universal key to the switch or lock, or as in the embodiment shown, the switch or lock can be operated by the use of the alternate key with the device attached. This gives one the ability to remove the device and use the manufacturers universal key as normal, or require the use of the alternate key to operate the switch, or lock when the device is attached. Furthermore, the Anti-theft lock device has additional advantages in that:
it can be used in combination with other types of switches to supply an added measure of security
the lock cylinders and key shafts in the device are easily interchangeable allowing one to operate different manufacturers switches and locks with one key
the device lock cylinders can be easily and inexpensively changed in the event an undesired person obtains a key to your device.

Although the description above contains many specificities, these should not be construed as limiting the scope of the embodiments but as merely providing illustrations of some of several embodiments. For example, different methods may be used to attach the device to the switch or lock assembly; the size and shape of rotation cylinders may be different; the size or type of cylinder lock used in the device may be altered, etc.

Thus the scope of the embodiments should be determined by the appended claims and their legal equivalents, rather than by the example given.

1. A universal switch and lock assembly comprising:
a) an ignition switch or lock operated by a universal key, containing a position whereby said key cannot be extracted,
b) a mechanism which when coupled with the switch or lock require said switch or lock to be operated by a non-universal key.
